(19) United States
(12) Patent Application Publication
(10) Pub. No.: US 2005/0227095 A1
(43) Pub. Date: Oct. 13, 2005

(54) Method for coating the surface of metal material with polymer and metal material whose surface is coated with polymer

(75) Inventor: Shin-ichi Kuroda, Maebashi-shi (JP)

Correspondence Address: HOGAN & HARTSON L.L.P., 500 S. GRAND AVENUE, SUITE 1900, LOS ANGELES, CA, 90071-2611, US

(73) Assignee: National University Corporation Gunma University

(21) Appl. No.: 11/064,908

(22) Filed: Feb. 23, 2005

(30) Foreign Application Priority Data
Apr. 12, 2004 (JP) 116411/2004

(51) Int. Cl. B32B 9/04

(52) U.S. Cl. 428/448; 427/402

(57) ABSTRACT

The present invention provides a method for coating the surface of a metal material with a polymer comprising the steps of coating an aqueous solution of silane coupling agent on a surface of a metal material and drying the solution to form thereby a silane coupling agent layer on the surface, coating an aqueous solution or dispersant containing acrylic monomers, vinyl monomers or styrene monomers at 0.5 to 30 wt. %, and a polymerization initiator capable of initiating the polymerization of the monomers over the surface of the metal material having the silane coupling agent layer formed thereupon, and polymerizing the monomers contained in the aqueous solution or dispersant coated in the foregoing step and drying the solution to form thereby a coat of an acryl polymer, vinyl polymer or styrene polymer over the silane coupling agent layer.

### BACKGROUND OF THE INVENTION

1. Field of the Invention

The present invention relates to a method for coating the surface of a metal material with a polymer, and to a metal material whose surface is coated with a polymer. More specifically, the present invention relates to a method for coating, with a polymer, the surface of a metal material obtained by assembling and processing parts.

2. Description of the Related Art

The generally known method for conferring anti-corrosion property to a metal material consists of metal-plating the surface of the metal material, or coating the surface of the metal material with a polymer. Coating the surface of a metal material with a polymer is usually performed by roll-coating a polymer on the surface of a planar metal material (see, for example, PCT/IB94/00102, WO94/27190 (claim 1, FIG. 1)). According to the invention disclosed in this patent publication, a coating material capable of undergoing cross-linking reaction when exposed to an electromagnetic wave is applied by roll-coating onto a surface of an electro-conductive material.

Another known method for coating a polymer on the surface of a metal material consists of mechanically cleaning the surface of a metal, treating the surface with a solution containing alkoxysilane in water-alcohol, subjecting the thus treated surface to heating treatment, and coating the surface with a composition containing, in addition to polyolefin, zeolite and carbon black (see, for example, Japanese Unexamined Patent Application Publication No. 63-166468 (Claims)). According to the invention described in this patent publication, coating the surface of a metal occurs by initially wetting the surface of a metal by dipping or by spraying, and then by applying the polyolefin-containing composition onto the surface by extrusion or by lamination.

When the surface of a metal material is metal-plated, waste solution left after the metal plating must be treated so that the level of contaminants contained in the solution does not exceed the standard level determined for environmental protection. Treatment of such waste solution requires multiple steps which poses a problem.

Problems are also posed when a polymer is coated on the surface of a metal material. Take, as an example, a radiator of an automobile whose manufacture requires a planar metal material to be processed into parts having complicated shapes, and the parts to be assembled into a finished form. If a surface of the planar metal material is coated with a polymer prior to assemblage, the coating particularly at or near joints will be destroyed, during assemblage, as a result of processing including welding. To compensate for the loss of coating during assemblage, it is necessary to recoat the surface of an assembled product. However, it is impossible to uniformly apply a polymer onto the entire surface of the product having a complicated form by roll-coating as described in PCT/IB94/00102, WO94/27190. Other coating methods are also inadequate in the formation of a uniform coat over the surface of a metal product having a complicated shape which poses a problem.

This also applies to a coating method as described in Japanese Unexamined Patent Application Publication No. 63-166468: it is hardly possible to uniformly coat the entire surface of a metal product having a complicated form with a polyolefin-containing composition.

### SUMMARY OF THE INVENTION

An object of the present invention is to provide a method for coating the surface of a metal material with a polymer whereby it is possible to uniformly form a coat of a polymer on the surface of a metal to confer anti-corrosion property to the metal, whether the metal material is planar, or is a product obtained by assembling metal parts and has a complicated shape.

Another object of the present invention is to provide a method for coating the surface of a metal material with a polymer whereby treatment of waste solution left after coating can be simplified.

Yet another object of the present invention is to provide a highly anti-corrosive metal material whose surface is coated with a polymer.

The inventive method described in claim 1 for coating the surface of a metal material comprises, as shown in FIGS. 1(b) to 1(e), a silane coupling agent treatment step comprising coating an aqueous solution of silane coupling agent on the surface of a metal material 10 and drying the coated solution to form a silane coupling agent layer 11 on the surface; a monomer coating step comprising coating an aqueous solution or dispersant 12 containing acrylic, vinyl or styrene monomers at 0.5 to 30 wt. % and a polimerization initiator capable of initiating the polymerization of the monomers over the silane coupling agent layer 11 formed on the surface of a metal material 10; and a polymerization treatment step comprising polymerizing monomers contained in the aqueous coating solution or dispersant 12 coated on the surface of a metal material 10, and drying the coated solution, thereby forming a coat 13 over the silane coupling agent layer 11 which is made of an acryl-, vinyl-, or styrene-based polymer.

According to the aspect of the invention described in claim 1, when an aqueous solution of a silane coupling agent is coated on the surface of a metal material, alkoxysilyl groups of the silane coupling agent turn into silanol groups which then react with hydroxyl groups on the surface of a metal material 10 to bind the silane coupling agent to the surface of a metal material 10 by condensation as shown in FIG. 1(c). When an aqueous solution or dispersant 12 containing monomers and a polymerization initiator is coated upon the silane coupling agent layer 11, organic moieties of the silane coupling agent copolymerize to be incorporated into a polymer. Namely, while monomers are being polymerized, the resulting polymer is adsorbed to the surface of a metal material. Thus, the bonding strength of the coat 13 made of the polymer to the metal material 10 is enhanced.

If the method further comprises a step of subjecting the surface of a metal material 10 to alkali treatment as shown in FIGS. 1(a) and 1(b) before the surface is coated with a silane coupling agent, hydroxyl groups are formed on the surface of a metal material 10. At the next step, when an aqueous solution of silane coupling agent is applied on the surface of the metal material, silanol groups derived from alkoxysilyl groups of the silane coupling agent readily react with the hydroxyl groups to achieve polycondensation.

The inventive metal material described in claim 7 is a metal material whose surface is coated with a polymer, the coating comprising forming a silane coupling agent layer 11 on the surface of a metal material 10, and then forming a coat 13, over the silane coupling agent layer 11, of an acrylic polymer, vinyl polymer or styrene polymer whose functional group is affinitive to an organic functional group of the silane coupling agent as shown in FIG. 1(e), by a method as described in claim 1.

If a coat of a polymer is directly formed on the surface of a metal material, the bonding strength of the coat to the surface of the metal material is inadequate. In contrast, with the invention as described in claim 7, a silane coupling layer 11 is interposed between a coat 12 of a polymer and the surface of a metal material 10, and thus the bonding strength of the coat 13 to the surface of the metal material 10 is enhanced.

The present invention provides following advantages.

(1) Even if the inventive method is applied for coating a metal product having a complicated shape obtained by assembling parts, not to mention a planar metal material, it is possible to uniformly form a coat of a polymer over the entire surface of the metal product and thereby to confer anti-corrosion property to the product.

(2) Since the coating solution is aqueous, treatment of waste solution left after coating the surface of a metal material with a polymer is simplified.

(3) According to the inventive method whereby a coat of a polymer is uniformly formed with a high affinity on the surface of a metal material, it is possible to obtain a metal material highly resistant to corrosion.

### BRIEF DESCRIPTION OF THE DRAWINGS

FIG. 1 is a schematic diagram for showing the steps of the inventive method for coating the surface of a metal material with a polymer.

FIG. 2(a) is a photograph of the surface of an Al-plate of Example 1 after alkali treatment. FIG. 2(b) is a photograph of the same surface after silane coupling agent treatment. FIG. 2(c) is a photograph of the same surface after polymerization treatment.

FIG. 3 shows XPS profiles of the surfaces of Al-plates of Example 1 and Comparative Example 1.

FIG. 4 shows an FE-SEM photomicrograph of the surface of an Al-plate of Example 1 after polymerization treatment.

FIG. 5 shows an FE-SEM photomicrograph of the surface of an Al-plate of Example 2 after polymerization treatment.

FIG. 6 shows an FE-SEM photomicrograph of the surface of an Al-plate of Comparative Example 2 after polymerization treatment.

FIG. 7 shows a photograph of the surface of an Al-plate of Example 1 having undergone the anti-corrosion test.

FIG. 8 shows a photograph of the surface of an Al-plate of Example 2 having undergone the anti-corrosion test.

FIG. 9 shows a photograph of the surface of an Al-plate of Comparative Example 2 having undergone the anti-corrosion test.

### DESCRIPTION OF THE PREFERRED EMBODIMENTS

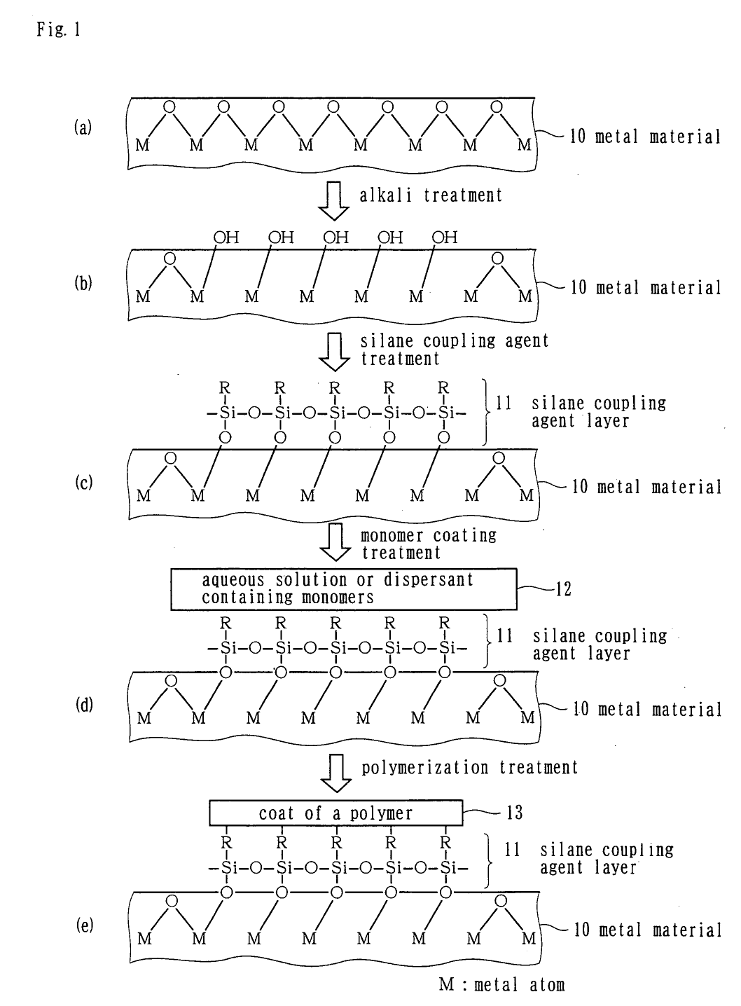

A preferred embodiment of the present invention will be described with reference to FIG. 1.

The metal material to which the inventive method is applied is not limited to any specific metal materials. However, preferred metal materials include aluminum, iron, zinc, lead, tin, titanium, copper, magnesium and their alloys, steel, stainless steel, etc. The metal material may take any shape including, in addition to a simple flat sheet, various complex forms obtained as a result of molding or by assembling multiple parts. The symbol M in FIGS. 1(a) to 1(e) represents metal atom.

(a Alkali Treatment

Preferably, the surface of a metal material 10 is treated in advance with alkali as shown in FIGS. 1(a) and 1(b). This treatment not only cleans the surface of a metal material 10, but also produces hydroxyl groups on the surface. For example, this alkali treatment consists of immersing the metal material in an aqueous solution containing sodium hydroxide or potassium hydroxide at 1 to 10 wt. %, removing the metal material from the solution, and drying it.

(b) Silane Coupling Agent Treatment

Then, as shown in FIG. 1(c), an aqueous solution of silane coupling agent (with the concentration of 0.1 to 2.0%) is coated on the surface of the metal material 10. The solution may further contain a 0.1-2.0% aqueous solution of acetic acid to promote hydrolysis of the silane coupling agent and to improve the stability of silanol. The silane coupling agent is a compound represented by the following formula (1):
RₙSi(OR′)₄₋ₙ (1)
where R represents an organic functional group comprising amino group or epoxy group, R′ alkyl group with 1 to 2 carbon atoms, and n is an integer of 1 to 3.

Suitable silane coupling agents may include, for example, aminopropyltriethoxysilane, N-(2-aminoethyl)-3-aminopropyltrimethoxysilane, 3-glycidoxypropyltriethoxysilane, p-styryltrimethoxysilane, 3-methacryloxypropyltrimethoxysilane, 3-acryloxypropyltrimethoxysilane, N-2(aminoethyl)3-aminopropyltrimethoxysilane, 3-isocyanatepropyltriethoxysilane, etc. When an aqueous solution of a silane coupling agent is coated on the surface of a metal material treated in advance with alkali, silanol groups (Si—OH) derived from alkoxysilyl groups of the silane coupling agent readily react with hydroxyl groups (OH) formed on the surface of the metal material in the foregoing step to achieve condensation as represented by the following formula (2) to form oxane bond with the surface of metal material:
Rₙ(SiOR′)₄₋ₙ- - >Hydrolysis- - >Rₙ—Si—(OH)₄₋ₙ (2)

A suitable silane coupling agent for the uniform and firm formation of a coat may be selected on the condition that it has an organic functional group highly affinitive to a functional group of a polymer of the invention. For example, if it is desired to form a polyacrylonitrile coat, preferably selected is a silane coupling agent having amino group which is affinitive to the functional group of acrylonitrile or the monomer of polyacrylonitrile. Alternatively, if it is desired to form a coat of polymethacrylate ester, preferably selected is a silane coupling agent having epoxy group which is affinitive to the functional group of methacrylate ester or the monomer of polymethacrylate ester. Coating of a silane coupling agent on a metal material occurs, if the metal material is a planar sheet, by dipping or spraying, or by roll-coating, and, if the metal material has a complicated shape, by dipping or spraying. After coating, the coating solution applied on the metal material is left at room temperature or heated to a temperature lower than 90° C. to be dried.

(c) Monomer Coating Treatment

A solution containing monomers and a polymerization initiator is then coated as shown in FIG. 1(d). The monomer is a compound which exists before a desired polymer forms a coat as a result of polymerization. Suitable monomers according to the invention may include acrylic monomers, vinyl monomers and styrene monomers. Illustratively, the preferred acrylic monomer, vinyl monomer and styrene monomer are acrylonitrile, methylpentene, and styrene, respectively. If polyacrylonitrile derived from the polymerization of acrylonitrile is used for the formation of a coat, the coat will prevent the penetration of oxygen, and be highly resistive to corrosion. The coating solution is an aqueous solution or dispersant 12 containing the aforementioned monomer at 0.5 to 30 wt. %, and a polymerization initiator to stimulate the polymerization of the monomer. The suitable solvent for the dispersant may include alcohol, water-alcohol mixture, etc. If the content of the monomer were below the lower limit of the above range, the coat would have such an inadequate thickness that it would not be able to cover the entire surface of a metal material. On the contrary, if the content of the monomer were over the upper limit of the above range, the coat would have an uneven texture. Preferably, the coating solution contains the monomer at 1 to 5 wt. %. Coating of an aqueous solution or dispersant containing monomers and a polymerization initiator capable of stimulating the polymerization of the monomers occurs, if a metal material is a flat metal sheet, by dipping, spraying or roll-coating, and, if a metal material has a complicated shape, by dipping or spraying.

(d) Polymerization Treatment

When a solution containing monomers and a polymerization initiator is coated on the silane-coupling agent treated surface of a metal material as shown in FIG. 1(e), the polymerization of monomers occurs, and the moieties of a resulting polymer and the organic moieties of the silane coupling agent attached to the surface of a metal material give rise to thermodynamic interaction which causes the polymer to be adsorbed by way of the silane coupling agent layer to the metal material. After the completion of polymerization, the coating solution is heated at a temperature lower than the melting point of the polymer, to be dried. This coating method allows a coat of a polymer to be uniformly and securely formed on the surface of a metal material, as long as a silane coupling agent layer is formed in advance on the surface, no matter how complicated form the metal material may take. According to this method, there is formed on the surface of a metal material a coat comprising a silane coupling agent layer having a thickness of several tens nanometers (several A) to several micrometers and thereupon an acrylic polymer layer and the like having a thickness of 0.1 to 100 μm.

### EXAMPLE

Examples of the present invention will be described in comparison with Comparative Examples.

### Example 1

A rectangular plate (Al-plate) made of pure aluminum 2 cm in length, 2 cm in width and 420 μm in thickness was prepared. The Al-plate was subjected in distilled water to ultrasonic cleaning for 20 minutes. Then, the plate was transferred into a sample vial having a capacity of 30 cm³. There, the plate underwent following treatments. The Al-plate was acid-treated with 30 wt. % aqueous solution of nitric acid at room temperature for 6 minutes. Then, the plate was alkali-treated with 6 wt. % aqueous solution of sodium hydroxide at room temperature for 2 minutes. The plate was further acid-treated with 30 wt. % aqueous solution of nitric acid at room temperature for 4 minutes. These treatments removed grease from the surfaces of the Al-plate, caused the formation of a deoxidation coat there, removed smut (impurities) therefrom, and finally caused the formation of hydroxyl groups there. The Al-plate was heated at 50° C. to be dried. The plate was then treated with a silane coupling agent comprised a compound having amino group at its terminal end or N-(2-aminoethyl)-3-aminopropyltrimethoxysilane [H₂N(CH₂)₂HN(CH₂)₃Si(OMe)₃] (TSL8340, GE Toshiba Silicon). The treatment proceeded as follows: the compound was dissolved in distilled water at 2% to provide an aqueous solution of the silane coupling agent; the above Al-plate was immersed in the aqueous solution for 10 minutes; and the plate was then heated at 80° C. for 1 hour to be dried. The treatment caused the formation of a silane coupling agent layer on the surfaces of the Al-plate.

Then, an aqueous solution containing acrylic monomers was coated by dipping over the silane coupling agent layer formed on the surfaces of the Al-plate. Concretely, a glass ball having a diameter of 18 mm was put in the sample vial having a capacity of 30 cm³, the Al-plate having a silane coupling agent layer formed on its surfaces was allowed to rest on the glass ball in the vial, 20 ml of distilled water was transferred into the vial, and nitrogen-substitution was continued for 10 minutes to remove oxygen which would interfere with polymerization. Then, 1 ml of acrylonitril or the acrylic monomer and 250 μl of 0.4% aqueous solution of potassium persulfate or a polymerization initiator were transferred into the vial, and the system was left at 70° C. for 5 hours. During the process, in water, the moieties of acrylonitrile or the acrylic monomer not only couple with the amino groups of the silane coupling agent anchored to the surface of Al-plate, but also allow acrylonitrile monomers to be polymerized. Then, the Al-plate was removed from the sample vial, and heated at 70° C. for 12 hours to be dried. On the surfaces of the Al-plate there were formed a silane coupling agent layer having a thickness of about 0.5 μm and a coat of polyacrylonitrile or an acrylic polymer over the above layer which had a thickness of about 5 μm.

### Example 2

A rectangular plate (Al-plate) made of pure aluminum 2 cm in length, 2 cm in width and 420 μm in thickness was prepared as in Example 1. The Al-plate, after being subjected in distilled water to ultrasonic cleaning as in Example 1, was acid-treated in a sample vial with 30 wt. % aqueous solution of nitric acid for 6 minutes, alkali-treated with 6 wt. % aqueous solution of sodium hydroxide for 2 minutes, and further acid-treated with 30 wt. % aqueous solution of nitric acid for 4 minutes in the same manner as in Example 1.

The used silane coupling agent comprised a compound having amino group at its terminal end or aminopropyltriethoxysilane [H₂N(CH₂)₃Si (OEt)₃] (TSL8331, GE Toshiba Silicon). The compound was dissolved in distilled water at 2% to give an aqueous solution of the silane coupling agent. The above Al-plate was immersed in the solution for 10 minutes, and dried in the same manner as in Example 1.

Then, as in Example 1, 1 ml of acrylonitril or the acrylic monomer and 250 μl of 0.4% aqueous solution of potassium persulfate or a polymerization initiator were transferred into the vial, and polymerization was allowed to occur in the same manner as in Example 1. Then, the Al-plate was removed from the sample vial, and heated at 70° C. for 12 hours to be dried. On the surfaces of the Al-plate there were formed a silane coupling agent layer having a thickness of about 0.5 μm and a coat of polyacrylonitrile or an acrylic polymer over the above layer which had a thickness of about 3 μm.

### Comparative Example 1

A rectangular plate (Al-plate) made of pure aluminum 2 cm in length, 2 cm in width and 420 μm in thickness was prepared as in Example 1. The Al-plate, after being subjected in distilled water to ultrasonic cleaning as in Example 1, was acid-treated in a sample vial with 30 wt. % aqueous solution of nitric acid for 6 minutes, alkali-treated with 6 wt. % aqueous solution of sodium hydroxide for 2 minutes, and further acid-treated with 30 wt. % aqueous solution of nitric acid for 4 minutes in the same manner as in Example 1.

The same silane coupling agent (TSL8340, GE Toshiba Silicon) as used in Example 1 was dissolved in distilled water at 2% to provide an aqueous solution of the silane coupling agent. The above Al-plate was immersed in the solution for 10 minutes, and dried in the same manner as in Example 1. The resulting Al-plate which received no polymerization treatment was made Comparative Example 1.

### Comparative Example 2

A rectangular plate (Al-plate) made of pure aluminum 2 cm in length, 2 cm in width and 420 μm in thickness was prepared as in Example 1. The Al-plate, after being subjected in distilled water to ultrasonic cleaning as in Example 1, was acid-treated in a sample vial with 30 wt. % aqueous solution of nitric acid for 6 minutes, alkali-treated with 6 wt. % aqueous solution of sodium hydroxide for 2 minutes, and further acid-treated with 30 wt. % aqueous solution of nitric acid for 4 minutes in the same manner as in Example 1.

The used silane coupling agent comprised a compound having vinyl group at its terminal end or vinyltrimethoxysilane [H₂C═CHSi(OMe)₃] (TSL8310, GE Toshiba Silicon). The compound was dissolved in 2% aqueous solution of acetic acid to give 2% aqueous solution of the silane coupling agent. The above Al-plate was immersed in the solution for 10 minutes, and dried in the same manner as in Example 1.

Then, as in Example 1, 1 ml of acrylonitril or the acrylic monomer and 250 μl of 0.4% aqueous solution of potassium persulfate or a polymerization initiator were transferred into the vial, and polymerization was allowed to occur in the same manner as in Example 1. Then, the Al-plate was removed from the sample vial, and heated at 70° C. for 12 hours to be dried. On the surfaces of the Al-plate there were formed a silane coupling agent layer having a thickness of about 0.5 μm and a coat of polyacrylonitrile or an acrylic polymer over the above layer which had a thickness of about 1 μm.

### Example 3

Instead of the pure Al-plate used in Example 1, a rectangular plate (Al—Mn alloy plate) 2 cm in length, 2 cm in width and 420 μm in thickness which was made of an Al—Mn alloy containing Mn at 0.5 wt. % was prepared. The Al—Mn alloy plate was treated as in Example 1. On the surfaces of the Al—Mn alloy plate, there were formed a silane coupling agent layer having a thickness of about 0.5 μm and a polyacrylonitrile coat having a thickness of about 5 μm over the above layer.

### Example 4

Instead of the pure Al-plate used in Example 2, a rectangular plate (Al—Mn alloy plate) 2 cm in length, 2 cm in width and 420 μm in thickness which was made of an Al—Mn alloy containing Mn at 0.5 wt. % was prepared. The Al—Mn alloy plate was treated as in Example 2. On the surfaces of the Al—Mn alloy plate, there were formed a silane coupling agent layer having a thickness of about 0.5 μm and a polyacrylonitrile coat having a thickness of about 3 μm over the above layer.

### Comparative Example 3

Instead of the pure Al-plate used in Comparative Example 1, a rectangular plate (Al—Mn alloy plate) 2 cm in length, 2 cm in width and 420 μm in thickness which was made of an Al—Mn alloy containing Mn at 0.5 wt. % was prepared. The Al—Mn alloy plate was treated as in Comparative Example 2. On the surfaces of the Al—Mn alloy plate, there were formed a silane coupling agent layer having a thickness of about 0.5 μm and a polyacrylonitrile coat having a thickness of about 1 μm over the above layer.

### Comparative Test and Evaluation

[1] Visual Inspection of the Al-Plates and Their Surface Analysis by XPS.

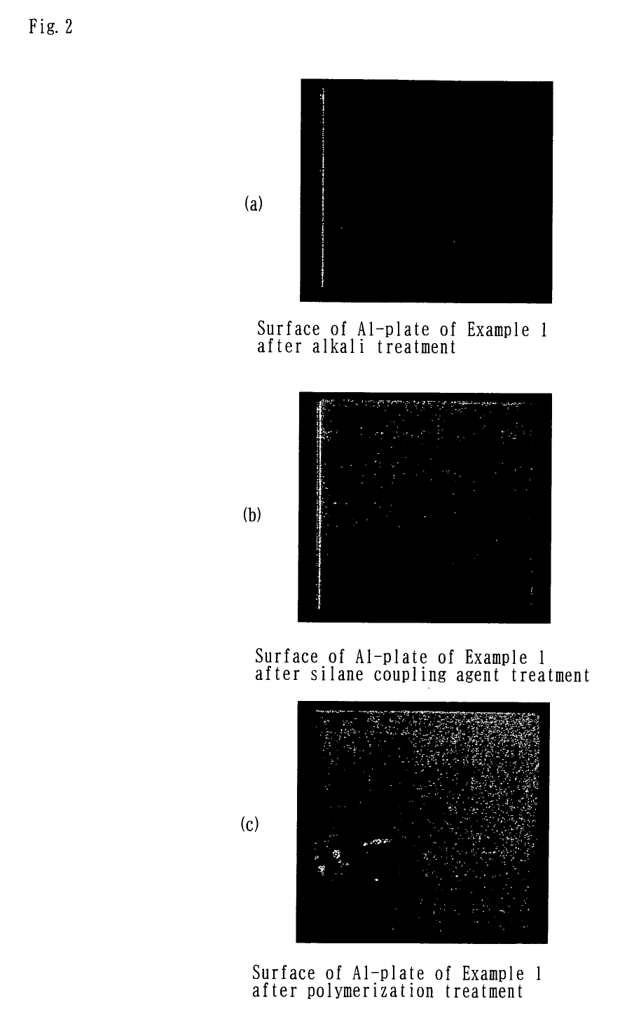

The surface condition of the Al-plate of Example 1 was visually inspected and analyzed by XPS (X-ray photon spectroscopy) after the alkali treatment, silane coupling agent treatment, and polymerization treatment. Visual inspection of the Al-plate after the alkali treatment revealed as shown in FIG. 2(a) that the Al-plate had a luster characteristic of aluminum metal, while XPS analysis confirmed that the surface was largely constituted of aluminum and oxygen.

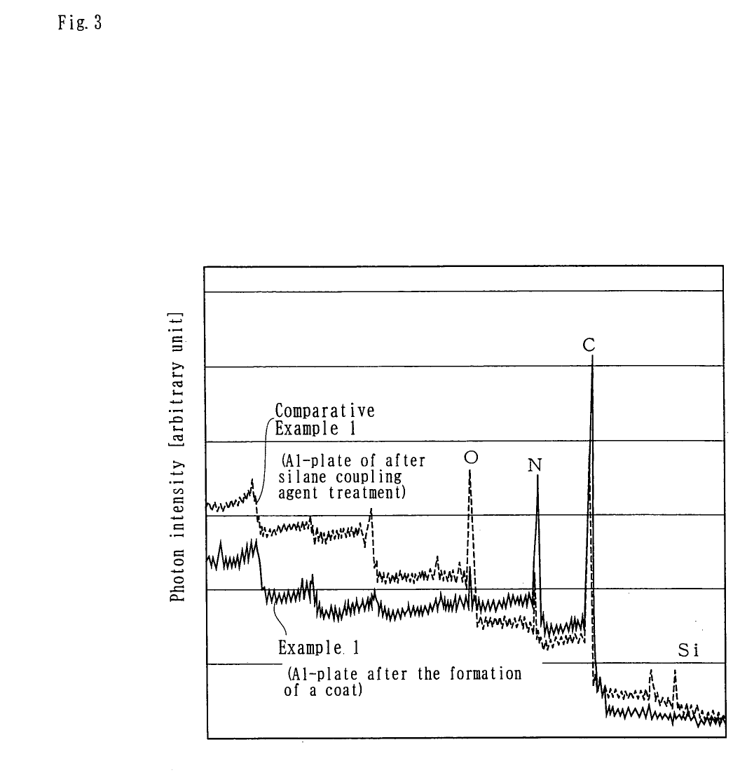

Visual inspection of the Al-plate after the silane coupling agent treatment revealed as shown in FIG. 2(b) that the surface looked similar to that of a pure Al-plate, while XPS analysis confirmed that peaks appeared at the positions corresponding to silicon, carbon and nitrogen or the constituents of the silane coupling agent with the reduction of aluminum. The XPS profile of the Al-plate of Example 1 after the silane coupling agent treatment was comparable to the XPS profile of the Al-plate of Comparative Example 1 shown in FIG. 3.

Visual inspection of the Al-plate after the polymerization treatment revealed as shown in FIG. 2(c) that the surface looked white, while XPS analysis confirmed that peaks corresponding to carbon and nitrogen or the constituents of polyacrylonitrile were enhanced as shown in FIG. 3.

[2] Observation of the Surface of Al-Plates by FE-SEM

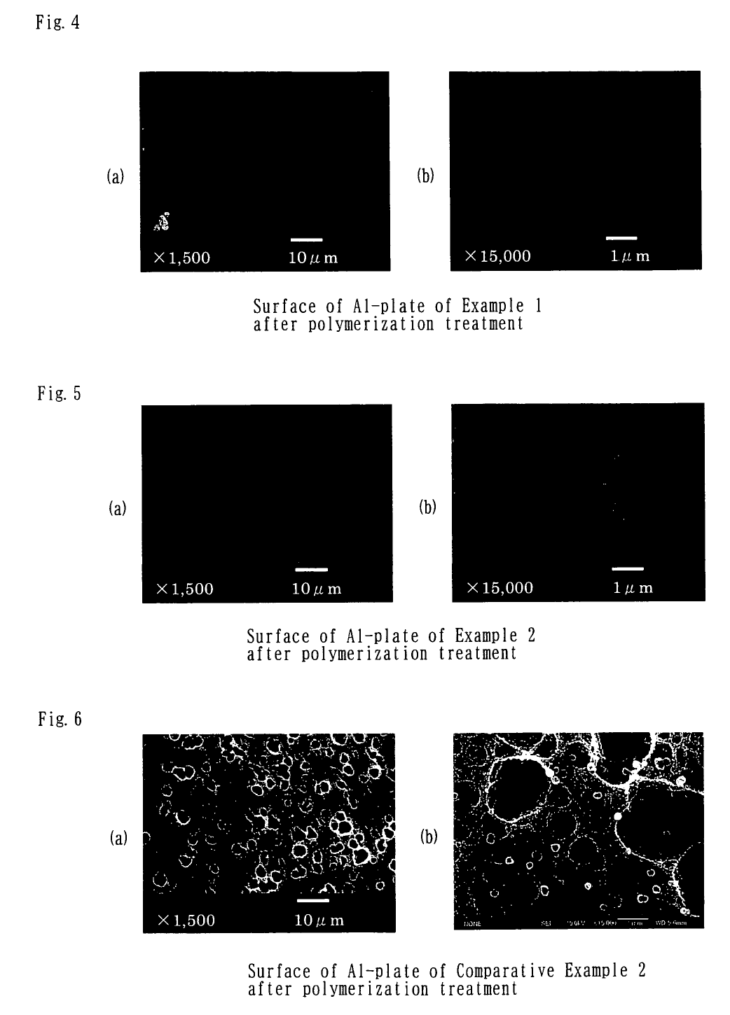

The Al-plates of Example 1, Example 2 and Comparative Example 2 after the polymerization treatment were observed for their surface condition by FE-SEM (field-emission scanning electronmicroscopy). The results obtained from the Al-plates of Example 1, Example 2 and Comparative Example 2 are shown in FIGS. 4, 5 and 6, respectively. The photos of FIGS. 4(b), 5(b) and 6(b) are 10 times enlargement of those of FIGS. 4(a), 5(a) and 6(a), respectively.

With regard to the Al-plate of Comparative Example 2, the polymer (polyacrylonitrile) coat covering its surfaces was particulate in appearance as shown in FIG. 6, and marked with multiple slits. In contrast, the Al-plate of Example 2 was covered with a coat having a particulate, dense texture as shown in FIG. 5. The Al-plate of Example 1 showed a non-particulate coat as shown in FIG. 4: the entire surface of the plate appeared to be covered with a coat having a layer superposed thereupon.

[3] Water-Proof and Anti-Corrosion Tests.

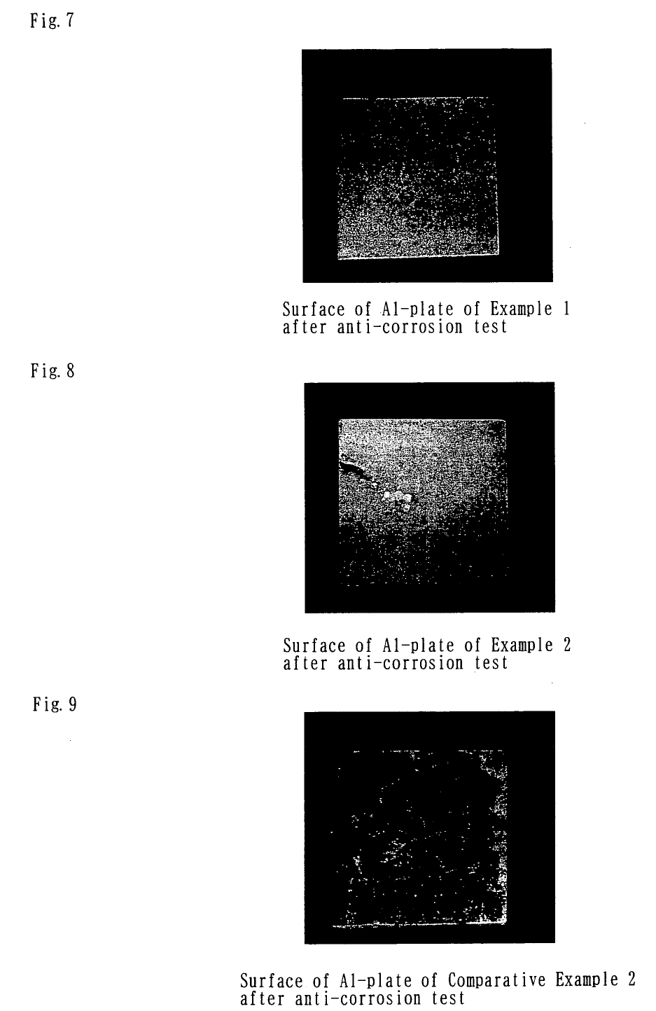

The Al- and Al—Mn plates of Examples 1-4 and of Comparative Examples 2-3 were tested for their water-proof and anti-corrosion activities. The water-proof test consisted of immersing the Al plate having undergone polymerization treatment in water kept at room temperature or at 90° C. for 1 week, and its surface was inspected for any change. The anti-corrosion test was conducted as follows. A 0.1 mol of glycine, 0.1 mol of sodium chloride, and 0.1 mol of hydrochloric acid were mixed to produce a buffer with pH 3, and the buffer was divided into three portions which were then kept at room temperature, 50° C. and 80° C. The Al plate having undergone polymerization treatment was immersed in one of the buffer baths for 1 week, and its surface was inspected for any change. The results of the water-proof and anti-corrosion tests performed on the metal plates of Examples 1-10 and of Comparative Examples 2-5 are listed in Table 1. The results of the anti-corrosion test performed on the metal plate of Examples 1 and 2 and of Comparative Example 2 are shown in FIGS. 7 to 9. In Table 1, “A” represents no tear-off, “B” partial tear-off, and “C” general tear-off. FIGS. 7, 8 and 9 show the surface condition of the metal plates of Example 1, Example 2 and Comparative Example 2 respectively after the anti-corrosion test.

TABLE 1

| | |
|---|---|
| Water-proof | Anti-corrosion |

| | room | | room | | |
|---|---|---|---|---|---|
| | temp. | 90° C. | temp. | 50° C. | 80° C. |
| Example 1 | A | A | A | A | A |
| Example 2 | A | A | A | B | B |
| Comp ex 2 | A | C | A | C | C |
| Example 3 | A | A | A | B | B |
| Example 4 | A | A | A | B | B |
| Comp Ex 3 | A | C | A | C | C |

As is obvious from Table 1, the Al-plate of Comparative Example 2 and Al—Mn plate of Comparative Example 3, after having undergone the water-proof test consisting of immersion in water kept at 90° C., or after having undergone the anti-corrosion test consisting of immersion in acidic buffer kept at 50° C. or 80° C. suffered from general peeling-off of their coats. In contrast, with the Al-plate of Example 2 and Al—Mn plates of Examples 3 and 4, their coats exhibited no peeling off after the water-proof test, while they suffered only from partial peeling off after they had been immersed in acidic buffer kept at 50° C. or 80° C. in the anti-corrosion test. The Al-plate of Example 1 exhibited no peeling off either subsequent to the water-proof test or to the anti-corrosion test.

1. A method for coating the surface of a metal material with a polymer comprising:
a silane coupling agent treatment step of coating an aqueous solution of silane coupling agent on a surface of a metal material (10) and drying the coated solution to form thereby a silane coupling agent layer (11) on the surface;
a monomer coating treatment step of coating an aqueous solution or dispersant (12) containing acrylic monomers, vinyl monomers or styrene monomers at 0.5 to 30 wt. %, and a polymerization initiator capable of initiating the polymerization of the monomers over the surface of the metal material (10) having the silane coupling agent layer (11) formed thereupon; and
a polymerization treatment step of polymerizing the monomers contained in the aqueous solution or dispersant (12) coated in the foregoing step and drying the solution to form thereby a coat (13) of an acryl polymer, vinyl polymer or styrene polymer over the silane coupling agent layer (11).

2. A method according to claim 1 wherein coating of an aqueous solution of silane coupling agent and of an aqueous solution or dispersant containing monomers and an polymerization initiator occurs by dipping, spraying, or roll-coating.

3. A method according to claim 1 wherein the silane coupling agent is a compound represented by the following formula (1):
RₙSi(OR′)₄₋ₙ (1)
where R represents an organic functional group comprising amino group or epoxy group, R′ alkyl group with 1 to 2 carbon atoms, and n an integer of 1 to 3.

4. A method according to claim 3 wherein the silane coupling agent has amino group at its terminal end, the acrylic monomer is acrylonitrile, the aqueous solution contains acrylonitrile and an polymerization initiator capable of initiating the polymerization of acrylonitrile, and the coat is made of polyacrylonitrile.

5. A method according to claim 1 further comprising a step of alkali-treating the surface of a metal material (10) prior to the silane coupling agent treatment step.

6. A method according to claim 5 wherein the alkali treatment comprises immersing a metal material in an aqueous solution of sodium hydroxide or potassium hydroxide.

7. A metal material whose surface is covered with a polymer coat which formation occurs by forming, by a method as described in claim 1, a silane coupling agent layer (11) on the surface of a metal material (10), and then forming a coat (13), over the silane coupling agent layer (11), of an acrylic polymer, vinyl polymer or styrene polymer whose functional group is affinitive to an organic functional group of the silane coupling agent.
